(19) United States
(12) Patent Application Publication
(10) Pub. No.: US 2025/0132676 A1
(43) Pub. Date: Apr. 24, 2025

(54) POWER CONVERTER

(71) Applicant: Murata Manufacturing Co., Ltd., Nagaokakyo-shi (JP)

(72) Inventors: Gang LI, Wuhan (CN); Yuanyuan YI, Wuhan (CN)

(21) Appl. No.: 18/913,057

(22) Filed: Oct. 11, 2024

(30) Foreign Application Priority Data
Oct. 18, 2023 (CN) 202311353703.8

(51) Int. Cl. H02M 3/158; H02M 3/00

(52) U.S. Cl. CPC H02M 3/158; H02M 3/01

(57) ABSTRACT

A power converter includes a first bridge arm connected between an input power supply and a reference potential, the first bridge arm including a first switch and a second switch connected at a first connection point, a second bridge arm connected in parallel with the first bridge arm between the input power supply and the reference potential, the second bridge arm including a first capacitor and a second capacitor connected at a second connection point, a coupling inductance connected between the first and second connection points, where a center tap of the coupling inductance is connected to a load, and a first resonant inductor connected in series with the coupling inductance between the first and second connection points, the first resonant inductor defining a series resonant circuit with each of the first capacitor and the second capacitor.

### CROSS REFERENCE TO RELATED APPLICATIONS

This application claims the benefit of priority to Chinese Patent Application No. 202311353703.8 filed on Oct. 18, 2023. The entire contents of this application hereby incorporated herein by reference.

### BACKGROUND OF THE INVENTION

### 1. Field of the Invention

The present disclosure relates to power converters, in particular to non-isolated power converters.

### 2. Description of the Related Art

A power converter is an electronic device that may convert a certain type of current into another type of current. There are DC power conversion and AC power conversion. Most intermediate bus converters (IBCs) provide isolation from input to output by using a transformer, and generally require an inductor for output filtering.

In existing communication systems, an isolated intermediate bus architecture is widely used for safety and power supply efficiency considerations. In such architecture, an input voltage of the system is converted into an intermediate voltage by an isolated intermediate bus converter (IBC), and then converted into a voltage required by a load circuit by a plurality of post-stage non-isolated load point power supplies.

Since a range of the input voltage that the load point power supply at the post-stage of the intermediate bus converter may adapt to is limited, the intermediate bus converter has to control an output voltage within a certain range. In order to adapt to a wider range of the input voltage, when the input voltage is transformed by the intermediate bus converter, an energy storage element such as an inductor has to continuously store and release more energy in the voltage conversion due to the wider range of input voltage, resulting in an increase in the volume and loss of the energy storage element.

However, non-isolated intermediate bus converters have been proposed in many new applications to achieve smaller dimension, higher efficiency and lower costs.

### SUMMARY OF THE INVENTION

According to an example embodiment of the present disclosure, a power converter includes a first bridge arm connected between an input power supply and a reference potential, the first bridge arm including a first switch and a second switch connected in series, and the first switch is connected to the second switch to define a first connection point, a second bridge arm connected in parallel with the first bridge arm between the input power supply and the reference potential, the second bridge arm including a first capacitor and a second capacitor connected in series, and the first capacitor is connected to the second capacitor to define a second connection point, a coupling inductance connected between the first connection point and the second connection point such that a center tap of the coupling inductance is connected to a load, and a first resonant inductor connected in series with the coupling inductance between the first connection point and the second connection point, the first resonant inductor defining a series resonant circuit with each of the first capacitor and the second capacitor.

In an example, in a power converter according to the present disclosure, the coupling inductance includes a first coil and a second coil magnetically coupled with the first coil. An end of the first coil is connected to an end of the second coil to define the center tap. The power converter further includes an output filtering capacitor, a third switch and a fourth switch each including a rectifier. Another end of the first coil is connected to the third switch. Another end of the second coil is connected to the fourth switch. The third switch is connected to the fourth switch to define a third connection point. The output filtering capacitor is connected between the center tap and the third connection point.

In an example, in a power converter according to an example embodiment of the present disclosure, the coupling inductance includes a third coil connected between the first coil and the second connection point.

In an example, in a power converter according to an example embodiment of the present disclosure, a capacitance of the first capacitor is equal to a capacitance of the second capacitor.

In addition, according to a power converter of an example embodiment of the present disclosure, the first resonant inductor includes a circuit parasitic inductance.

In an example, in a power converter according to an example embodiment of the present disclosure, a resonant frequency of the series resonant circuit is equal to an operating frequency of the power converter.

In an example, in a power converter according to an example embodiment of the present disclosure, a number of turns of the first coil is equal to a number of turns of the second coil.

In an example, in a power converter according to an example embodiment of the present t disclosure, the coupling inductance further includes a first coil and a second coil magnetically coupled with the first coil. An end of the first coil is connected to an end of the second coil to define the center tap. Another end of the first coil is connected to the second connection point. Another end of the second coil is connected to the first connection point. The power converter further includes an output filtering capacitor, a first rectifier bridge arm and a second rectifier bridge arm, where each of the first rectifier bridge arm and the second rectifier bridge arm is connected in parallel with the output filtering capacitor. The first rectifier bridge arm includes a third switch and a fifth switch connected in series. A connection point at which the third switch is connected with the fifth switch is connected to the center tap. The second rectifying bridge arm includes a fourth switch and a sixth switch connected in series. A connection point at which the fourth switch is connected with the sixth switch is connected to the first connection point. An end of the output filtering capacitor is connected to the fourth switch and the fifth switch. Another end of the output filtering capacitor is connected to the third switch and the sixth switch.

In an example, in a power converter according to an example embodiment of the present disclosure, a number of turns of the first coil is zero, and a number of turns of the second coil is any natural number.

In an example, in a power converter according to an example embodiment of the present disclosure, a first group of switches includes the first switch and the third switch. A second group of switches includes the second switch and the fourth switch. The first group of switches are controlled to be turned on or off synchronously. The second group of switches are controlled to be turned on or off synchronously. The first group of switches and the second group of switches are controlled to have an identical turn-on duty cycle.

In an example, in a power converter according to the present disclosure, each of the first group of switches and the second group of switches is controlled to have a turn-on duty cycle of 50% without considering dead zone. A phase difference between a control signal of the first group of switches and a control signal of the second group of switches is 180 degrees.

In an example, in a power converter according to an example embodiment of the present disclosure, the first group of switches includes the first switch, the third switch and the fourth switch. The second group of switches includes the second switch, the fifth switch and the sixth switch. The first group of switches are controlled to be turned on or off synchronously. The second group of switches are controlled to be turned on or off synchronously. The first group of switches and the second group of switches are controlled to have an identical turn-on duty cycle.

In an example, in a power converter according to an example embodiment of the present disclosure, each of the first group of switches and the second group of switches is controlled to have a turn-on duty cycle of 50% without considering dead zone. A phase difference between a control signal of the first group of switches and a control signal of the second group of switches is 180 degrees.

In an example, in a power converter according to an example embodiment of the present disclosure, the power converter further includes a reference potential controller to control a voltage of the reference potential. The reference potential controller includes a third capacitor connected between the reference potential and a standard potential, a third bridge arm connected between an input power supply and the standard potential, the third bridge arm including a fifth switch and a sixth switch connected in series, and the fifth switch being connected to the sixth switch to define a fourth connection point, and a second resonant inductor connected between the fourth connection point and the reference potential.

In an example, in a power converter according to an example embodiment of the present disclosure, the reference potential controller further includes fourth bridge arm connected between the reference potential and the standard potential, the fourth bridge arm including a seventh switch and an eighth switch connected in series, and the seventh switch being connected to the eighth switch to define a fifth connection point. The second resonant inductor is connected between the fourth connection point and the fifth connection point.

The above and other elements, features, steps, characteristics and advantages of the present invention will become more apparent from the following detailed description of the example embodiments with reference to the attached drawings.

### BRIEF DESCRIPTION OF THE DRAWINGS

The purposes, advantages and features of the present disclosure mentioned above will become more apparent through the detailed description of example embodiments with reference to the following combined accompanying drawings.

FIG. 1 is a block diagram illustrating a configuration structure of a main portion of a power converter according to a first example embodiment of the present invention.

FIG. 2 is a schematic diagram illustrating an example of switching timing of switches in the power converter according to the first example embodiment of the present invention.

FIG. 3 is a schematic diagram illustrating a flow direction of a power current in the power converter according to the first example embodiment of the present invention.

FIG. 4 is a schematic diagram illustrating the flow direction of the power current in the power converter according to the first example embodiment of the present invention.

FIG. 5 is a schematic diagram illustrating waveforms of currents flowing through the switches in the power converter according to the first example embodiment of the present invention.

FIG. 6 is a block diagram illustrating a configuration structure of a main portion of a power converter according to a second example embodiment of the present invention.

FIG. 7 is a block diagram illustrating a configuration structure of a main portion of a power converter according to a third example embodiment of the present invention.

FIG. 8 is a block diagram illustrating a configuration structure of a main portion of a power converter according to a fourth example embodiment of the present invention.

FIG. 9 is a block diagram illustrating a configuration structure of a main portion of a power converter according to a fifth example embodiment of the present invention.

### DETAILED DESCRIPTION OF THE EXAMPLE EMBODIMENTS

The present disclosure is further described in detail below in conjunction with the accompanying drawings and example embodiments. It may be understood that the specific example embodiments described herein are only used to explain the present invention, rather than to limit the present invention. Furthermore, it should be noted that, for ease of description, only the elements, features, characteristics, etc., related to example embodiments of the present invention are shown in the accompanying drawings. In addition, there are cases where the same elements are labeled with the same symbols and repeated descriptions are omitted. In addition, there are cases where repeated descriptions are omitted for elements with the same or corresponding functions and structures.

Example embodiments of the present disclosure provide power converters each capable of achieving soft switching. Hereinafter, the present disclosure will be explained in detail with reference to the accompanying drawings.

### First Example Embodiment

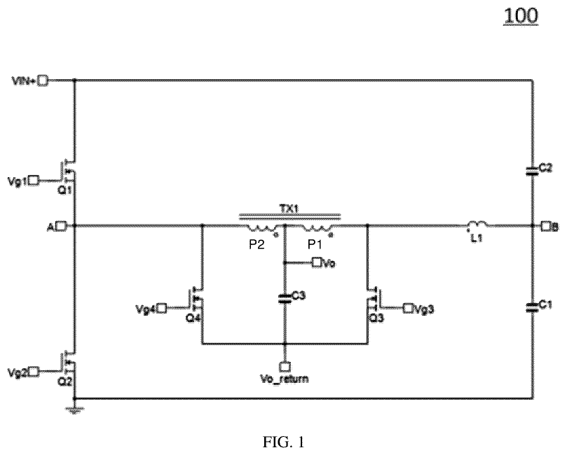

FIG. 1 is a block diagram illustrating a configuration structure of a main portion of a power converter according to a first example embodiment of the present disclosure. As shown in FIG. 1, the power converter 100 of the first example embodiment of the present disclosure includes four switches Q1 to Q4, a coupling inductance TX1, capacitors C1 to C3, and a resonant inductor. In this example embodiment, the switches may be various transistors, and the same applies to other example embodiments.

As shown in FIG. 1, in the first example embodiment of the present disclosure, the power converter 100 includes a switch Q1, a switch Q2, a switch Q3, a switch Q4, a coupling inductance TX1, a capacitor C1, a capacitor C2 and a capacitor C3. In the power converter 100 of this example embodiment, the switch Q1 (first switch) and the switch Q2 (second switch) connected in series may be implemented to define a first bridge arm. The switch Q1 is connected to the switch Q2 to define a first connection point A. The capacitor C1 (first capacitor) and the capacitor C2 (second capacitor) connected in series may be implemented to define a second bridge arm. The capacitor C1 is connected to the capacitor C2 to define a second connection point B. In addition, in the power converter 100 of this example embodiment, the coupling inductance TX1 is connected between the first connection point A and the second connection point B, and a center tap of the coupling inductance TX1 is connected to a load. The resonant inductor L1 (first resonant inductor) and the coupling inductance TX1 are connected in series between the first connection point A and the second connection point B, and forms a series resonant circuit with each of the capacitor C1 and the capacitor C2. In an example embodiment, the resonant inductor L1 is connected between the coupling inductance TX1 and the second connection point B. In the present disclosure, the resonant inductor L1 may include a circuit parasitic inductance.

In this example embodiment, as shown in FIG. 1, the coupling inductance TX1 includes a coil P1 (first coil) and a coil P2 (second coil) magnetically coupled with the coil P1 (first coil). In this example embodiment, an end of the coil P1 is connected to an end of the coil P2 to define a center tap, which is connected to the load. It should be noted that an opposite-polarity end of the coil P1 may be connected to a common-polarity end of the coil P2. Alternatively, a common-polarity end of the coil P1 may be connected to an opposite-polarity end of the coil P2. Another end of the coil P1 is connected to the switch Q3 (third switch), and another end of the coil P2 is connected to the switch Q4 (fourth switch). The switch Q3 is connected to the switch Q4 to define a third connection point Vo return. The capacitor C3 is connected between the center tap and the third connection point Vo return. In this example embodiment, the capacitor C3 acts as an output filtering capacitor, and the switch Q3 and the switch Q4 act as rectifiers.

In this example embodiment, the switch Q1 is connected to an input power supply VIN+, and the switch Q2 is connected to the reference potential. Here, the reference potential may be a grounded potential or other adjustable potentials. The first bridge arm and the second bridge arm are connected in parallel between the input power supply and the reference potential, where the first bridge arm includes the switch Q1 and the switch Q2 connected in series, and the second bridge arm includes the capacitor C1 and the capacitor C2 connected in series.

In this example embodiment, regarding a polarity relationship between the coil P1 and the coil P2, common-polarity ends are shown with dots in FIG. 1. Since the power converter 100 of this example embodiment is implemented to be a non-isolated power converter, there are no strictly defined primary and secondary sides as referred to in an isolated power converter.

It should be noted that the power converter 100 of this example embodiment is further provided with a control circuit to provide control signals Vg1 to Vg4 to gates of the switches Q1 to Q4. However, since the present disclosure does not involve the specific structure of the control circuit, the control circuit is not shown and detailed description of the control circuit is omitted in order to make the description of the present disclosure clearer.

Next, operating modes of the power converter 100 of this example embodiment will be described.

In the power converter 100 of this example embodiment, a first group of switches includes the switch Q1 and the switch Q3, and corresponding control signals Vg1 and Vg3 are synchronized. A second group of switches includes the switch Q2 and the switch Q4, and corresponding control signals Vg2 and Vg4 are synchronized. In this example embodiment, the first group of switches are controlled to be turned on or off synchronously, and the second group of switches are controlled to be turned on or off synchronously. The first group of switches and the second group of switches are controlled to have an identical turn-on duty cycle. A phase difference between a control signal of the first group of switches and a control signal of the second group of switches is 180 degrees. For example, when the control signals Vg1 and Vg3 are at high level, the control signals Vg2 and Vg4 are at low level. A phase difference between each of the control signals Vg1 and Vg3 and each of the control signals Vg2 and Vg4 is 180 degrees. In a half cycle, the switch Q1 and the switch Q3 are turned on by controlling the control signals Vg1 and Vg3 to provide a high level, so that the switch Q1 and the switch Q3 simultaneously have a turn on duty cycle of 50%. In the other half cycle, the switch Q2 and the switch Q4 are turned on by controlling the control signals Vg2 and Vg4 to provide a high level, so that the switch Q2 and the switch Q4 simultaneously have a turn on duty cycle of 50%. It should be noted that the duty cycle here is the duty cycle without considering dead zone.

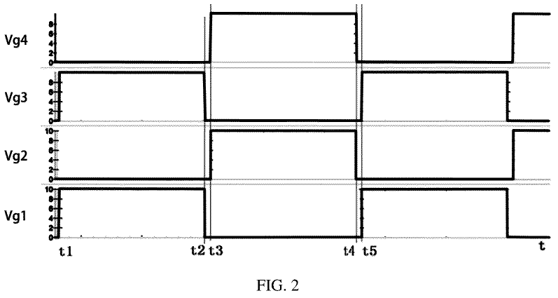

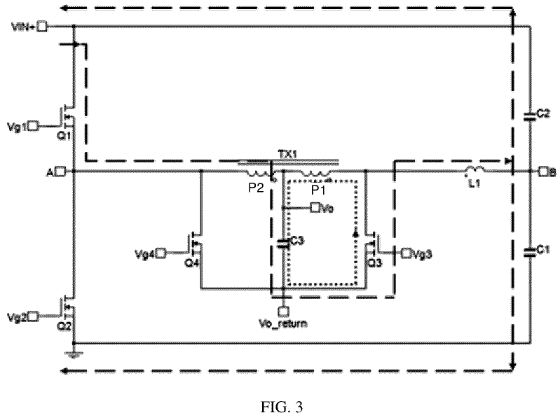

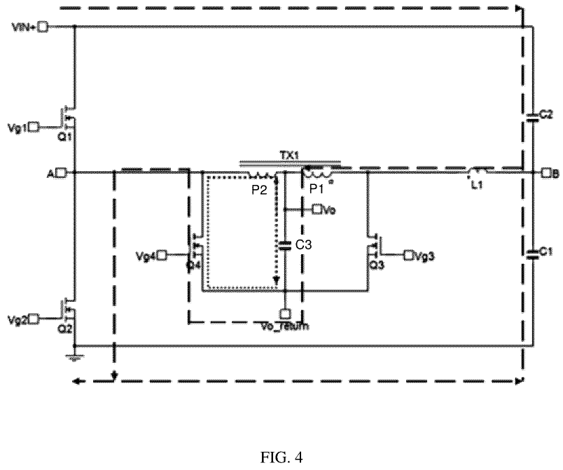

FIG. 2 is a schematic diagram illustrating an example of switching timing of switches in the power converter according to the first example embodiment of the present disclosure. FIG. 3 is a schematic diagram illustrating a flow direction of a power current in the power converter according to the first example embodiment of the present disclosure. FIG. 4 is a schematic diagram illustrating the flow direction of the power current in the power converter according to the first example embodiment of the present disclosure.

As shown in FIG. 2, in a period of t1 to t2, the control signals Vg1 and Vg3 are at high level, and the control signals Vg2 and Vg4 are at low level. Therefore, the switch Q1 and the switch Q3 are turned on, the switch Q2 and the switch Q4 are turned off, and the power current in the circuit is shown in FIG. 3. As shown in FIG. 2, in a period of t3 to t4, the control signals Vg1 and Vg3 are at low level, and the control signals Vg2 and Vg4 are at high level. Therefore, the switch Q1 and the switch Q3 are turned off, the switch Q2 and the switch Q4 are turned on, and the power current in the circuit is shown in FIG. 4.

When the switch Q1 and the switch Q3 are turned on and the switch Q2 and the switch Q4 are turn off, as shown in FIG. 3, a voltage at the first connection point A becomes a voltage of the input power supply VIN+ due to the turning on of the switch Q1, so that a voltage difference is formed between the first connection point A and the second connection point B. Accordingly, current flows from the input power supply VIN+ to the second coil P2 through the switch Q1 and the first connection point A, and flows to the second connection point B through the capacitor C3, the switch Q3 and the resonant inductor L1. Since the current from the first connection point A to the second connection point B is generated, a current flowing to the input power supply VIN+ through the capacitor C2 and a current flowing to the reference potential through the capacitor C1 are generated, as shown in FIG. 3. In addition, since the coil P1 is magnetically coupled with the coil P2, a demagnetization current from the coil P1 to the capacitor C3 and the switch Q3 is generated. In a case that a number of turns of the coil P1 is equal to a number of turns of the coil P2, the two currents have the same magnitude with parasitic being ignored. It should be noted that in the process of operating in this half cycle, it may be equivalent to that the capacitor C1 is charged and the capacitor C2 is discharged.

When operating in the other half cycle, that is, when the switch Q1 and the switch Q3 are turned off and the switch Q2 and the switch Q4 are turned on, as shown in FIG. 4, a voltage at the first connection point A becomes a voltage of the reference potential due to the turning on of the switch Q2, so that a voltage difference is formed between the first connection point A and the second connection point B. Accordingly, current flows from the second connection point B to the first connection point A through the resonant inductor L1, the coil P1, the capacitor C3 and the switch Q4, flows to the reference potential through the switch Q2, and flows to the outside. Since the current from the second connection point B to the first connection point A is generated, a current flowing from the input power supply VIN+ to the capacitor C2 and a current flowing from the reference potential to the capacitor C1 are generated, as shown in FIG. 4. Similarly, since the coil P1 is magnetically coupled with the coil P2, a demagnetization current from the coil P2 to the capacitor C3 and the switch Q4 is generated. In a case that a number of turns of the coil P1 is equal to a number of turns of the coil P2, the two currents have the same magnitude with parasitic being ignored. It should be noted that in the process of operating in this half cycle, it may be equivalent to that the capacitor C1 is discharged and the capacitor C2 is charged.

In this example embodiment, since the capacitor C1 and the capacitor C2 act as resonant capacitors, it is preferred that a capacitance of capacitor C1 is equal to a capacitance of the capacitor C2. In this way, the structures of the resonant capacitors become symmetrical. In addition, in this example embodiment, it is preferred that an operating frequency of the power converter 100 is equal to a resonant frequency of each of the capacitor C1 and the capacitor C2 with the resonant inductor L1. The resonant frequency of each of the capacitor C1 and the capacitor C2 with the resonant inductor L1 may be calculated by an equation 1 as follows:

$$fr = 1 / 2 π / ( Lr * Cr ) \hat{} 0.5 \qquad equation 1$$

where fr is a resonant frequency, Lr is an inductance value of the resonant inductor L1, and Cr is a capacitance value of the capacitor C1 or a capacitance value of the capacitor C2. Furthermore, in this example embodiment, it is preferred that the number of turns of the coil P1 is equal to the number of turns of the coil P2. In this way, a gain ratio of the output voltage Vo to the input voltage Vin may be achieved to be 1:4.

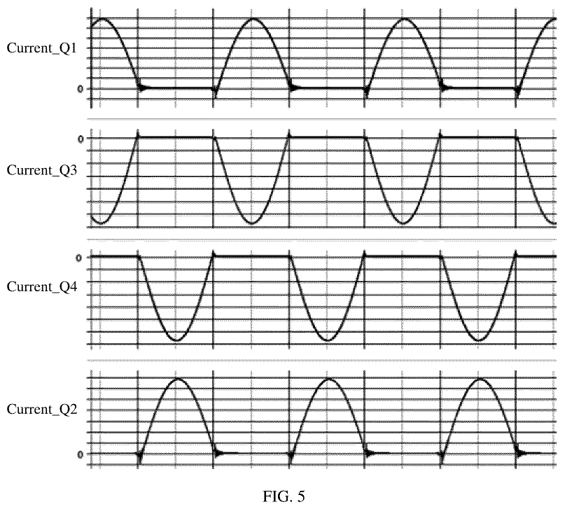

The operating mode of the power converter 100 in this example embodiment has been simulated through simulation. FIG. 5 is a schematic diagram illustrating waveforms of currents flowing through the switches in the power converter according to the first example embodiment of the present disclosure. In FIG. 5, a current Q1 flowing through the switch Q1, a current Q2 flowing through the switch Q2, a current Q3 flowing through the switch Q3, and a current Q4 flowing through the switch Q4 are shown as an example. In this example embodiment, as shown in FIG. 5, current passes through a transistor when the switch is turned on, and the current is approximately zero when the switch is turned off. Therefore, each switch in this example embodiment may be turned on at zero voltage and turned off at zero current, thereby achieving soft switching and reducing the switching loss of each switch. Moreover, since Vds of each switch has no spike, it is helpful for selecting a MOS transistor with a lower voltage resistance.

Furthermore, in this example embodiment, in practical applications, the resonant inductor L1 may be replaced by a transformer leakage inductance in a case that the switching frequency is high, so that an actual inductor is not required, saving space and costs.

Furthermore, in this example embodiment, by using LLC, the duty cycle D≈50% (slightly less than 50%) remains unchanged. As compared with traditional isolated half-bridge LLC, an effective value of the coils (primary and secondary sides) passing through the transformer may be reduced.

Furthermore, in this example embodiment, the resonant capacitor structure has a symmetrical structure, so that an input ripple current may be reduced.

### Second Example Embodiment

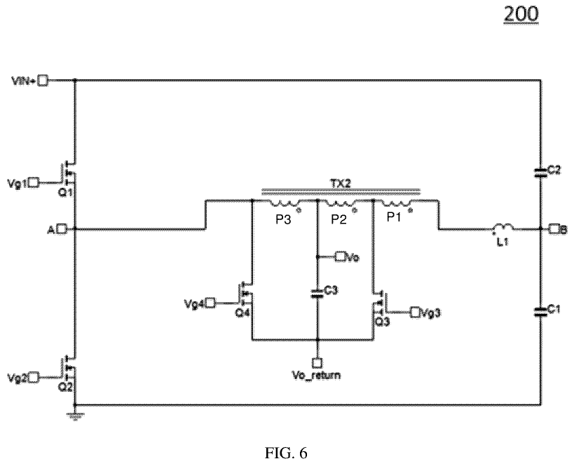

FIG. 6 is a block diagram illustrating a configuration structure of a main portion of a power converter according to a second example embodiment of the present disclosure.

The power converter 200 of the second example embodiment is different from the power converter 100 of the first example embodiment mainly in that the structure of the coupling inductance is different. Hereinafter, description will be made mainly on the differences. In the second example embodiment, structures that are same as those in the first example embodiment are denoted by same reference numerals, and descriptions of the same structures and the same functions and effects based on the same structures are omitted.

As shown in FIG. 6, the power converter 200 of this example embodiment includes a coupling inductance TX2. The coupling inductance TX2 includes a coil P2 (first coil) and a coil P3 (second coil) connected in series. The coupling inductance TX2 further includes a coil P1 (third coil). The coil P1 is connected between the coil P2 and the second connection point B. A number of turns of the coil P1 is set to n1, a number of turns of the coil P2 is equal to a number of turns of the coil P3, and each of the number of turns of the coil P2 and the number of turns of the coil P3 is set to n2. When n1 is 0, the structure of the power converter 200 in this example embodiment becomes the same as the structure of the power converter 100 in the first example embodiment.

In this example embodiment, a relationship between the output voltage Vo and the input voltage Vin satisfies an equation 2 as follows:

$$Vo = Vin * n 2 / ( 2 * n 1 + 4 n 2 ) . \qquad equation 2$$

In this example embodiment, a gain ratio of the output voltage to the input voltage may be adjusted by adjusting the numbers n1 and n2 of turns of the coils. Moreover, an output gain ratio being a fixed ratio may be achieved in a case that the numbers n1 and n2 of turns of the coils are fixed.

### Third Example Embodiment

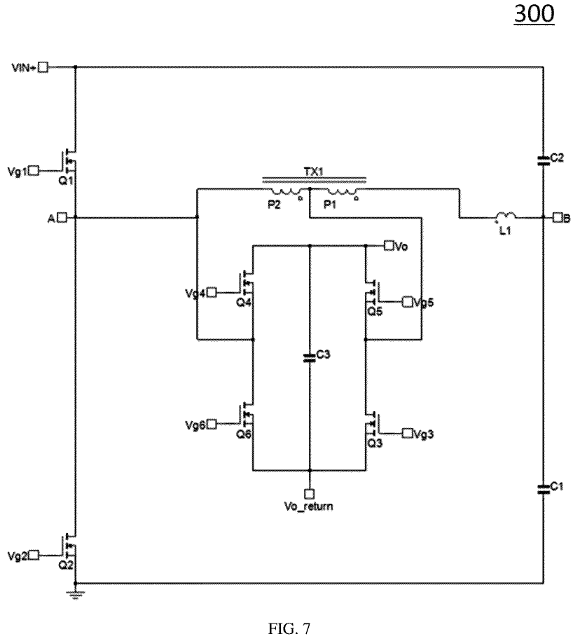

FIG. 7 is a block diagram illustrating a configuration structure of a main portion of a power converter according to a third example embodiment of the present disclosure.

The power converter 300 of the third example embodiment is different from the power converter 100 of the first example embodiment mainly in that the structure of the output rectifier is different. Hereinafter, description will be made mainly on the differences. In the third example embodiment, structures that are same as those in the first example embodiment are denoted by same reference numerals, and descriptions of the same structures and the same functions and effects based on the same structures are omitted.

As shown in FIG. 7, in the power converter 300 of this example embodiment, similarly to the power converter 100 of the first example embodiment, the coupling inductance TX1 includes a coil P1 (first coil) and a coil P2 (second coil), where the coil P1 (first coil) is magnetically coupled with the coil P2 (second coil). An end of the coil P1 is connected to an end of the coil P2 to define a center tap. In addition, as shown in FIG. 7, in the power converter 300 of this example embodiment, another end of the coil P1 is connected to the second connection point B, and another end of the coil P2 is connected to the first connection point A. The power converter 300 of this example embodiment includes a capacitor C3, a first rectifier bridge arm and a second rectifier bridge arm, where each of the first rectifier bridge arm and the second rectifier bridge arm is connected in parallel with the capacitor C3. The first rectifier bridge arm includes a switch Q3 (third switch) and a switch Q5 (fifth switch) connected in series, and a connection point at which the switch Q3 is connected with the switch Q5 is connected to the center tap. The second rectifier bridge arm includes a switch Q4 (fourth switch) and a switch Q6 (sixth switch) connected in series, and a connection point at which the switch Q4 is connected with the switch Q6 is connected to the first connection point A. An end of the capacitor C3 is connected to the switch Q4 and the switch Q5. Another end of the capacitor C3 is connected to the switch Q3 and the switch Q6.

In this example embodiment, the capacitor C3 acts as an output filtering capacitor. The switch Q3, the switch Q4, the switch Q5 and the switch Q6 act as rectifiers.

In the power converter 400 of this example embodiment, a first group of switches includes a switch Q1, a switch Q3, and a switch Q4, and control signals Vg1, Vg3 and Vg4 corresponding to the first group of switches are synchronized. A second group of switches includes a switch Q2, a switch Q5 and a switch Q6, and control signals Vg2, Vg5 and Vg6 corresponding to the second group of switches are synchronized. In this example embodiment, the first group of switches are controlled to be turned on or off synchronously, and the second group of switches are controlled to be turned on or off synchronously. The first group of switches and the second group of switches are controlled to have an identical turn-on duty cycle. A phase difference between a control signal of the first group of switches and a control signal of the second group of switches is 180 degrees. For example, when the control signals Vg1, Vg3 and Vg4 are at high level, the control signals Vg2, Vg5 and Vg6 are at low level, and the phase difference between each of the control signals Vg1, Vg3 and Vg4 and each of the control signals Vg2, Vg5 and Vg6 is 180 degrees. In a half cycle, the switch Q1, the switch Q3 and the switch Q4 are turned on by the control signals Vg1, Vg3 and Vg4 at high level, so that the switch Q1, the switch Q3 and the switch Q4 are simultaneously turned on for duty cycle of 50%. In the other half cycle, the switch Q2, the switch Q5 and the switch Q6 are turned on by the control signals Vg2, Vg5 and Vg6 at high level, so that the switch Q2, the switch Q5 and the switch Q6 are simultaneously turned on for duty cycle of 50%. It should be noted that the duty cycle here is a duty cycle without considering dead zone.

Furthermore, in this example embodiment, the number of turns of the coil P1 and the number of turns of the coil P2 may be any natural number.

In this example embodiment, when the number of turns of the coil P1 is n1 and the number of turns of the coil P2 is n2, a relationship between the output voltage Vo and the input voltage Vin satisfies an equation 3 as follows:

$$Vo = Vin * n 2 / ( 2 * n 1 + 2 n 2 ) . \qquad equation 3$$

In this example embodiment, a gain ratio of the output voltage to the input voltage may be adjusted by adjusting the numbers n1 and n2 of turns of the coils. Moreover, an output gain ratio being a fixed ratio may be achieved in a case that the numbers n1 and n2 of turns of the coils are fixed.

Furthermore, in this example embodiment, it is preferred that when the number of turns of the coil P1 is zero, the number of turns of the coil P2 is any natural number. Furthermore, in this example embodiment, it is preferred that when the number of turns of the coil P2 is zero, the number of turns of the coil P1 is zero.

### Fourth Example Embodiment

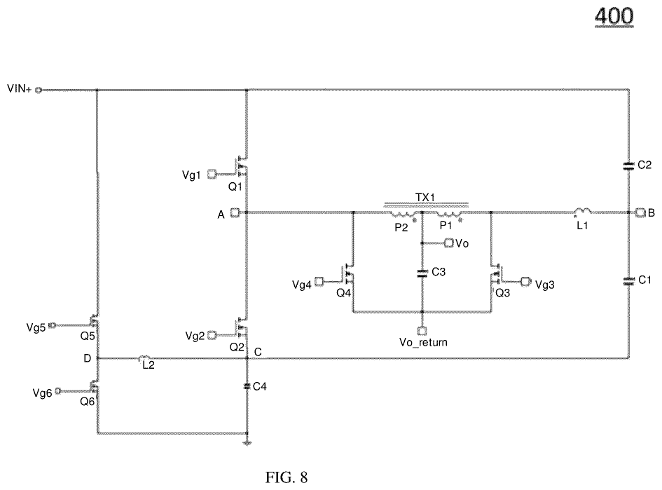

FIG. 8 is a block diagram illustrating a configuration structure of a main portion of a power converter according to a fourth example embodiment of the present disclosure.

The power converter 400 of this example embodiment is different from the power converter 100 of the first example embodiment mainly in that the power converter 400 further includes a reference potential controller for controlling a voltage of a reference potential. Hereinafter, description will be made mainly on the differences. In the fourth example embodiment, structures that are same as those in the first example embodiment are denoted by same reference numerals, and descriptions of the same structures and the same functions and effects based on the same structures are omitted.

In the power converter 400 of this example embodiment, as shown in FIG. 8, the reference potential controller includes a switch Q5 (fifth switch), a switch Q6 (sixth switch), a resonant inductor L2 (second resonant inductor) and a capacitor C4 (third capacitor). As shown in FIG. 8, the capacitor C4 is connected between a reference potential C and a standard potential. Here, the reference potential may be a ground potential. The switch Q5 and the switch Q6 are connected in series between the input power supply VIN+ and the reference potential, and the switch Q5 and the switch Q6 are connected to define a fourth connection point D. Here, it may be seen as the switch Q5 and the switch Q6 defining a third bridge arm. That is, the third bridge arm is connected between the input power supply VIN+ and the reference potential, where the third bridge arm includes the switch Q5 and the switch Q6 connected in series. In addition, the resonant inductor L2 is connected between the fourth connection point D and the reference potential C.

In this example embodiment, the control circuit further provides control signals Vg5 and Vg6 to a gate of each of the switch 05 and the switch 06. The control signal Vg5 is complementary with the control signal Vg6, so that switch Q5 and the switch Q6 are complementarily turned on. When the turn-on duty cycle of the switch Q5 is set to dl, a relationship between the output voltage Vo and the input voltage Vin satisfies an equation 4 as follows:

$$Vo = Vin * ( 1 - d 1 ) / 4. \qquad equation 4$$

According to this example embodiment, a gain ratio of the output voltage to the input voltage may be adjusted by controlling the turn-on duty cycle of the switch Q5.

In this example embodiment, for example, if Vin=48 and the required Vo=1, d1=(Vin−4Vo)/Vin=91.7% is determined according to the equation 4.

For a BUCK converter, the greater a value of d1, the higher the efficiency. It may be seen that when Vo<<Vin, the value of d1 is large, so that BUCK stage may achieve high efficiency. For a non-isolated LLC resonant converter with a fixed DC gain of ¼, it is also possible to achieve high efficiency.

### Fifth Example Embodiment

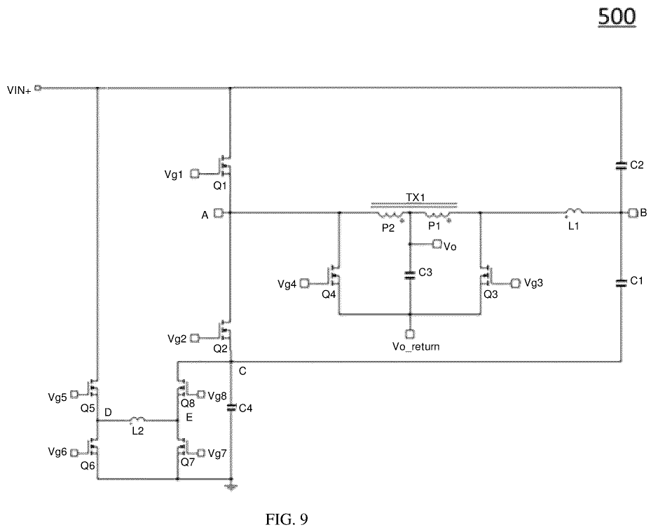

FIG. 9 is a block diagram illustrating a configuration structure of a main portion of a power converter according to a fifth example embodiment of the present disclosure.

The power converter 500 of this example embodiment is different from the power converter 400 of the fourth example embodiment mainly in that a reference potential controller in the power converter 500 is replaced by a BUCK BOOST converter. Hereinafter, description will be made mainly on the differences. In the fifth example embodiment, structures that are same as those in the fourth example embodiment are denoted by same reference numerals, and descriptions of the same structures and the same functions and effects based on the same structures are omitted.

In the power converter 500 of this example embodiment, as shown in FIG. 9, the reference potential controller further includes a fourth bridge arm. The fourth bridge arm is connected between the reference potential C and a standard potential, where the fourth bridge arm includes a switch Q7 (seventh switch) and a switch Q8 (eighth switch) connected in series. The switch Q7 is connected to the switch Q8 to define a fifth connection point E. The resonant inductor L2 is connected between the fourth connection point D and the fifth connection point E.

In this example embodiment, the control circuit further provides control signals Vg5, Vg6, Vg7 and Vg8 to a gate of each of the switch Q5, the switch Q6, the switch Q7 and the switch Q8. The control signals Vg5, Vg6, Vg7 and Vg8 are PWM (Pulse Width Modulation) signals with the same frequency. The control signal Vg5 is complementary with the control signal Vg6, and the turn-on duty cycle of the control signal Vg5 is set to d1. The control signal Vg7 is complementary with the control signal Vg8, and the turn-on duty cycle of the control signal Vg7 is set to d2. By controlling the turn-on duty cycles d1 and d2, as well as a phase angle between the control signal Vg6 and the control signal Vg6, the switches Q5, 06, Q7 and Q8 form a BUCK-BOOST conversion through the resonant inductor L2 and the capacitor C4, controlling voltages at two ends of the capacitor C4, thus controlling a voltage at the reference potential C.

According to this example embodiment, it is possible to perform BUCK-BOOST control on the voltage at the reference potential C.

Furthermore, in the present disclosure, any modifications and substitutions conceivable by those skilled in the art may be made to the BUCK control in the fourth example embodiment and the BUCK-BOOST control in the fifth example embodiment.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A power converter, comprising:
a first bridge arm connected between an input power supply and a reference potential, the first bridge arm including a first switch and a second switch connected in series, and the first switch is connected to the second switch to define a first connection point;
a second bridge arm connected in parallel with the first bridge arm between the input power supply and the reference potential, the second bridge arm including a first capacitor and a second capacitor connected in series, and the first capacitor is connected to the second capacitor to define a second connection point;
a coupling inductance connected between the first connection point and the second connection point such that a center tap of the coupling inductance is connected to a load; and
a first resonant inductor connected in series with the coupling inductance between the first connection point and the second connection point, the first resonant inductor defining a series resonant circuit with each of the first capacitor and the second capacitor.

2. The power converter of claim 1, wherein
the coupling inductance includes a first coil and a second coil magnetically coupled with the first coil;
an end of the first coil is connected to an end of the second coil to define the center tap;
the power converter further comprises an output filtering capacitor, a third switch and a fourth switch each including a rectifier;
another end of the first coil is connected to the third switch;
another end of the second coil is connected to the fourth switch;
the third switch is connected to the fourth switch to define a third connection point; and
the output filtering capacitor is connected between the center tap and the third connection point.

3. The power converter of claim 2, wherein the coupling inductance includes a third coil connected between the first coil and the second connection point.

4. The power converter of claim 1, wherein a capacitance of the first capacitor is equal to a capacitance of the second capacitor.

5. The power converter of claim 1, wherein the first resonant inductor includes a circuit parasitic inductance.

6. The power converter of claim 1, wherein a resonant frequency of the series resonant circuit is equal to an operating frequency of the power converter.

7. The power converter of claim 2, wherein a number of turns of the first coil is equal to a number of turns of the second coil.

8. The power converter of claim 1, wherein
the coupling inductance includes a first coil and a second coil magnetically coupled with the first coil;
an end of the first coil is connected to an end of the second coil to define the center tap, another end of the first coil is connected to the second connection point, and another end of the second coil is connected to the first connection point;
the power converter further comprises an output filtering capacitor, a first rectifier bridge arm and a second rectifier bridge arm, each of the first rectifier bridge arm and the second rectifier bridge arm being connected in parallel with the output filtering capacitor;
the first rectifier bridge arm includes a third switch and a fifth switch connected in series, and a connection point at which the third switch is connected with the fifth switch is connected to the central tap;
the second rectifier bridge arm includes a fourth switch and a sixth switch connected in series, and a connection point at which the fourth switch is connected with the sixth switch is connected to the first connection point;
an end of the output filtering capacitor is connected to the fourth switch and the fifth switch; and
another end of the output filtering capacitor is connected to the third switch and the sixth switch.

9. The power converter of claim 8, wherein
a number of turns of the first coil is zero; and
a number of turns of the second coil is any natural number.

10. The power converter of claim 2, wherein
a first group of switches includes the first switch and the third switch;
a second group of switches includes the second switch and the fourth switch;
the first group of switches are controlled to be turned on or off synchronously;
the second group of switches are controlled to be turned on or off synchronously; and
the first group of switches and the second group of switches are controlled to have an identical turn-on duty cycle.

11. The power converter of claim 10, wherein
each of the first group of switches and the second group of switches is controlled to have a turn-on duty cycle of 50% without considering dead zone; and
a phase difference between a control signal of the first group of switches and a control signal of the second group of switches is 180 degrees.

12. The power converter of claim 8, wherein
the first group of switches includes the first switch, the third switch, and the fourth switch;
the second group of switches includes the second switch, the fifth switch and the sixth switch;
the first group of switches are controlled to be turned on or off synchronously;
the second group of switches are controlled to be turned on or off synchronously; and
the first group of switches and the second group of switches are controlled to have an identical turn-on duty cycle.

13. The power converter of claim 12, wherein
each of the first group of switches and the second group of switches is controlled to have a turn-on duty cycle of 50% without considering dead zone;
a phase difference between a control signal of the first group of switches and a control signal of the second group of switches is 180 degrees.

14. The power converter of claim 1, further comprising a reference potential controller configured or programmed to control a voltage of the reference potential; wherein
the reference potential controller includes:
a third capacitor connected between the reference potential and a standard potential;
a third bridge arm connected between an input power supply and the standard potential, the third bridge arm including a fifth switch and a sixth switch connected in series, and the fifth switch is connected to the sixth switch to define a fourth connection point; and
a second resonant inductor connected between the fourth connection point and the reference potential.

15. The power converter of claim 1, wherein
the reference potential controller includes a fourth bridge arm connected between the reference potential and the standard potential, wherein the fourth bridge arm includes a seventh switch and an eighth switch connected in series, and the seventh switch is connected to the eighth switch to define a fifth connection point; and
the second resonant inductor is connected between the fourth connection point and the fifth connection point.
